(19) United States
(12) Patent Application Publication
(10) Pub. No.: US 2026/0108998 A1
(43) Pub. Date: Apr. 23, 2026

(54) RANDOM ORBIT SANDER

(71) Applicant: MILWAUKEE ELECTRIC TOOL CORPORATION, Brookfield, WI (US)

(72) Inventors: Alex D. Servais, Slinger, WI (US); Daniel J. Chartier, New Berlin, WI (US)

(21) Appl. No.: 19/361,612

(22) Filed: Oct. 17, 2025

Related U.S. Application Data
(60) Provisional application No. 63/708,992, filed on Oct. 18, 2024.

(51) Int. Cl. B24B 23/03; B24B 55/10; B25F 5/00; B25F 5/02

(52) U.S. Cl. CPC B24B 23/03; B24B 55/102; B25F 5/006; B25F 5/008; B25F 5/02

(57) ABSTRACT

An orbital sander may include a housing defining a handle portion and a motor housing portion, a motor within the motor housing and including a motor shaft defining a motor axis, an eccentric drive unit coupled to the motor shaft and configured to convert rotation of the motor shaft to an orbit motion around the motor axis, a battery receptacle on the handle portion that is configured to receive a battery pack for providing electrical current to the motor, a backing pad coupled to the eccentric drive unit for orbital motion about the motor axis, and a dust collection assembly including a dust shroud into which an airflow containing dust created during a sanding operation is induced. The motor housing portion and the dust shroud are in fluid communication with each other.

### CROSS-REFERENCE TO RELATED APPLICATION

This application claims priority to U.S. Provisional Ser. No. 63/708,992 filed on Oct. 18, 2024, the entire content of which is incorporated herein by reference.

### FIELD OF THE DISCLOSURE

The present disclosure relates to random orbit sanders, and more particularly to dust collection assemblies for random orbit sanders.

### BACKGROUND OF THE DISCLOSURE

Random orbit sanders are used to smooth workpieces that include wood, metal, etc. Improvements in these tools are always sought after in the industry.

### SUMMARY OF THE DISCLOSURE

The present disclosure provides, in one aspect, an orbital sander including: a housing defining a handle portion and a motor housing portion; a motor within the motor housing portion and including a motor shaft defining a motor axis; an eccentric drive unit coupled to the motor shaft and configured to convert rotation of the motor shaft to an orbit motion around the motor axis; a battery receptacle on the handle portion that is configured to receive a battery pack for providing electrical current to the motor; a backing pad coupled to the eccentric drive unit for orbital motion about the motor axis; and a dust collection assembly including a dust shroud into which an airflow containing dust created during a sanding operation is induced, wherein the motor housing portion and the dust shroud are in fluid communication with each other.

The present disclosure provides, in one aspect, an orbital sander, wherein the dust collection assembly further includes a dust fan disposed within the dust shroud, and wherein the dust fan is directly driven by the motor shaft.

The present disclosure provides, in one aspect, an orbital sander, wherein the dust shroud includes a first plurality of apertures and the motor housing portion includes a second plurality of apertures, and wherein the motor housing portion is in fluid communication with the dust shroud via, in sequence, the second plurality of apertures and the first plurality of apertures.

The present disclosure provides, in one aspect, an orbital sander, wherein the first plurality of apertures includes a first set of apertures having a first diameter and a second set of apertures having a second diameter that is greater than the first diameter.

The present disclosure provides, in one aspect, an orbital sander, wherein the second plurality of apertures includes a first set of apertures having a first diameter and a second set of apertures having a second diameter that is greater than the first diameter.

The present disclosure provides, in one aspect, an orbital sander, wherein the first plurality of apertures and the second plurality of apertures collectively define a venting area of approximately 150 square millimeters to approximately 290 square millimeters.

The present disclosure provides, in one aspect, an orbital sander, wherein the housing further defines a shroud portion in which at least a portion of the dust shroud is received and an opening extending through the shroud portion of the housing to communicate with an exterior surroundings of the orbital sander, wherein the opening is in fluid communication with the dust shroud via the first plurality of apertures, and wherein the opening is in fluid communication with the motor housing portion via the second plurality of apertures, such that the dust shroud and the motor housing portion are simultaneously in fluid communication with the exterior surroundings of the orbital sander via the opening.

The present disclosure provides, in one aspect, an orbital sander, further including a bearing that supports the motor shaft for rotation and that is located within a bearing pocket between the motor housing portion and the dust shroud.

The present disclosure provides, in one aspect, an orbital sander, wherein the housing further defines a shroud portion in which at least a portion of the dust shroud is received, wherein the motor housing portion and the dust shroud are in fluid communication with each other via a plurality of apertures, and wherein the plurality of apertures reduce a pressure differential between the motor housing portion and the shroud portion of the housing.

The present disclosure provides, in another aspect, an orbital sander including: a housing defining a handle portion and a motor housing portion; a motor within the motor housing portion and including a motor shaft defining a motor axis; an eccentric drive unit coupled to the motor shaft and configured to convert rotation of the motor shaft to an orbit motion around the motor axis; a backing pad coupled to the eccentric drive unit for orbital motion about the motor axis; a dust collection assembly including a dust shroud in which a low-pressure region is created for drawing dust away from the backing pad; a bearing supported within a bearing pocket that is disposed between the motor housing portion and the dust shroud; and an aperture that fluidly communicates the motor housing portion with the dust shroud and that transmits airflow within the motor housing portion around the bearing pocket and toward the low-pressure region.

The present disclosure provides, in one aspect, an orbital sander, wherein the dust collection assembly further includes a dust fan disposed within the dust shroud, and wherein the dust fan is directly driven by the motor shaft.

The present disclosure provides, in one aspect, an orbital sander, wherein the aperture is a first plurality of apertures extending through the dust shroud, and wherein the motor housing portion includes a second plurality of apertures that fluidly communicate the motor housing portion and the dust shroud.

The present disclosure provides, in one aspect, an orbital sander, wherein the first plurality of apertures includes a first set of apertures having a first diameter and a second set of apertures having a second diameter that is greater than the first diameter.

The present disclosure provides, in one aspect, an orbital sander, wherein the second plurality of apertures includes a first set of apertures having a first diameter and a second set of apertures having a second diameter that is greater than the first diameter.

The present disclosure provides, in one aspect, an orbital sander, wherein the first plurality of apertures and the second plurality of apertures collectively define a venting area of approximately 150 square millimeters to approximately 290 square millimeters.

The present disclosure provides, in one aspect, an orbital sander, wherein the housing defines a shroud portion in which at least a portion of the dust shroud is received and an opening extending through the shroud portion of the housing to communication with an exterior surroundings of the orbital sander, wherein the opening is in fluid communication with the dust shroud via the first plurality of apertures, and wherein the opening is in fluid communication with the motor housing portion via the second plurality of apertures, such that the dust shroud and the motor housing portion are simultaneously in fluid communication with the exterior surroundings of the orbital sander via the opening.

The present disclosure provides, in one aspect, an orbital sander, wherein the motor shaft is rotatably supported within the housing by the bearing.

The present disclosure provides, in one aspect, an orbital sander, wherein the aperture reduces pressure differential between the motor housing portion and the dust shroud.

The present disclosure provides, in one aspect, an orbital sander, wherein the dust shroud is selectively coupled to a vacuum for creating the low-pressure region.

The present disclosure provides, in one aspect, an orbital sander, wherein the bearing includes an outer race interfaced with the bearing pocket, an inner race interfaced with the motor shaft, a plurality of rollers between the outer race and the inner race, and an annular seal extending between the inner race and the outer race.

The present disclosure provides, in one aspect, an orbital sander, wherein the annular seal is exposed to the low-pressure region within the dust shroud, and wherein the aperture reduces a pressure differential on the annular seal.

The present disclosure provides, in yet another aspect, an orbital sander including: a housing defining a first cavity and a second cavity; a motor within the housing and including a motor shaft defining a motor axis; an eccentric drive unit coupled to the motor shaft and configured to convert rotation of the motor shaft to an orbit motion around the motor axis; a backing pad coupled to the eccentric drive unit for orbital motion about the motor axis; a bearing that supports the motor shaft for rotation about the motor axis and is disposed between the first cavity and the second cavity; and a means for placing the first cavity in fluid communication with the second cavity and for redirecting airflow around the bearing.

The present disclosure provides, in one aspect, an orbital sander, wherein the motor is disposed within the first cavity, and wherein a dust shroud is disposed within the second cavity.

The present disclosure provides, in one aspect, an orbital sander, further including a wall that separates the first cavity and the second cavity, wherein the communication means is an aperture extending through the wall.

The present disclosure provides, in one aspect, an orbital sander, wherein the communication means is an aperture that reduces a pressure differential around the bearing.

The present disclosure provides, in one aspect, an orbital sander, wherein the aperture defines a venting area of approximately 150 square millimeters to approximately 290 square millimeters.

The present disclosure provides, in one aspect, an orbital sander, further including an opening extending through the housing and in fluid communication with the aperture, such that the first cavity and the second cavity are simultaneously in fluid communication with the exterior surroundings of the orbital sander via the opening.

Other features and aspects of the disclosure will become apparent by consideration of the following detailed description and accompanying drawings.

### BRIEF DESCRIPTION OF THE DRAWINGS

FIG. 1 is a perspective view of a random orbit sander.

FIG. 2 is side view of the random orbit sander of FIG. 1.

FIG. 3 is a bottom view of the random orbit sander of FIG. 1.

FIG. 4 is a cross-section view of the random orbit sander of FIG. 1 taken along line 4-4 in FIG. 3.

FIG. 5 is a perspective view of a handle portion of the random orbit sander of FIG. 1, illustrating a battery receptacle.

FIG. 6 is a perspective view of a dust collection assembly of the random orbit sander of FIG. 1.

FIG. 7 is a perspective view of an upper shroud of the dust collection assembly of FIG. 6.

FIG. 8 is a plan view of the upper shroud of FIG. 7, illustrating a first plurality of apertures.

FIG. 9 is a plan view of a motor housing portion of the random orbit sander, illustrating a second plurality of apertures.

FIG. 10 is a perspective view of a random orbit sander in accordance with another embodiment of the invention, illustrating part of a motor housing portion removed to expose a dust collection assembly.

FIG. 11 is a plan view of an upper shroud of the dust collection assembly of FIG. 10, illustrating a first plurality of apertures.

FIG. 12 is a plan view of the motor housing portion of FIG. 10, illustrating a second plurality of apertures.

FIG. 13 is a rear perspective of the random orbit sander of either FIG. 1 or FIG. 10, illustrating an opening in the motor housing portion.

Before any embodiments of the present disclosure are explained in detail, it is to be understood that the embodiments described herein are not limited in scope or application to the details of construction and the arrangement of components set forth in the following description or as illustrated in the following drawings. The devices described herein are capable of other embodiments and of being practiced or of being carried out in various ways. Also, it is to be understood that the phraseology and terminology used herein is for the purpose of description and should not be regarded as limiting.

### DETAILED DESCRIPTION

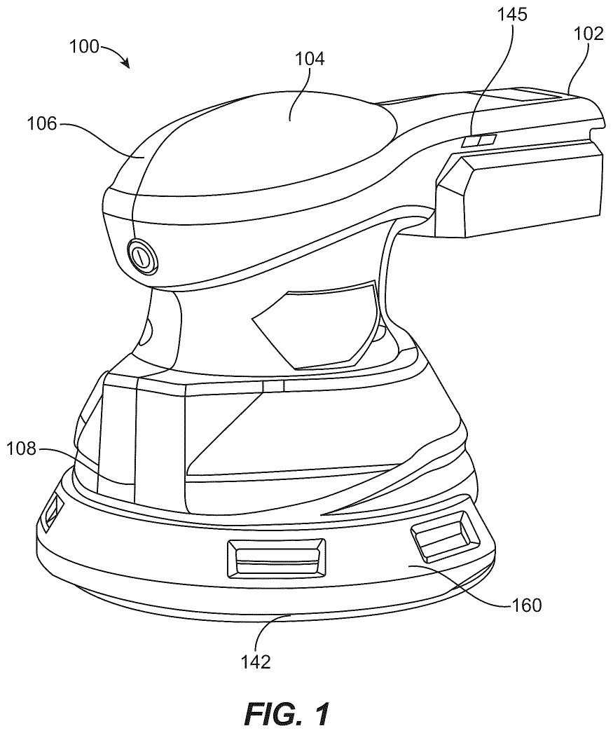

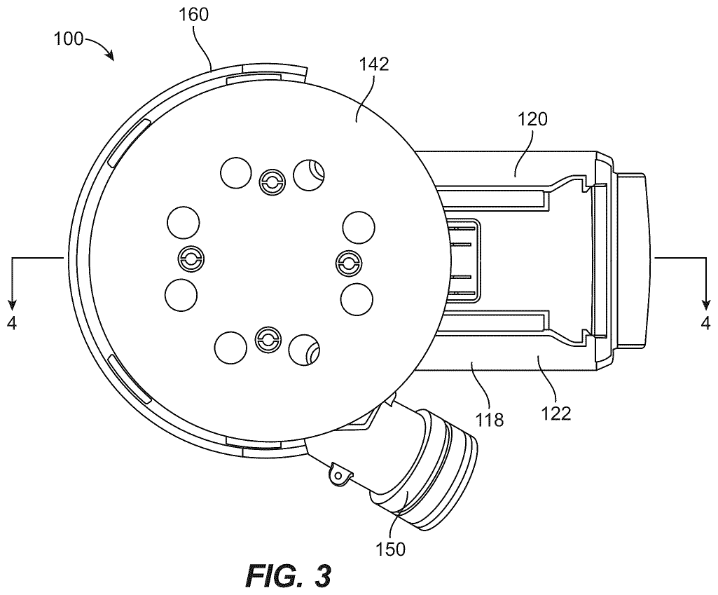

Referring to FIGS. 1-4, a random orbit sander 100 is illustrated. The random orbit sander 100 includes a housing 102 having a first housing shell 104 joined to a second housing shell 106 along a seam 108. Further, the housing 102 includes a motor housing portion 110 extending along a motor axis 112. The first housing shell 104 and the second housing shell 106 define many ribs, surfaces, and/or projections that separate or hold various components within the housing 102, including a wall 113 that defines a lower portion of the motor housing portion 110. A handle portion 114 extends from the motor housing portion 110 along a handle axis 116. In a particular aspect, the handle axis 116 is perpendicular to the motor axis 112. The random orbit sander 100 further includes a battery receptacle 118 formed in the handle portion 114 that is configured to receive a battery pack. Specifically, the battery receptacle 118 includes a pair of parallel guide rails 120, 122 that are configured to receive complementary features on a removable battery back. As such, the battery receptacle 118 is sized and shaped to slidably receive a removable battery pack therein. The removable battery pack is slidable parallel to the handle axis 116 in a first direction toward the motor axis 112 to be engaged with the battery receptacle 118 and in a second direction away from the motor axis 112 (opposite the first direction) to be disengaged from the battery receptacle.

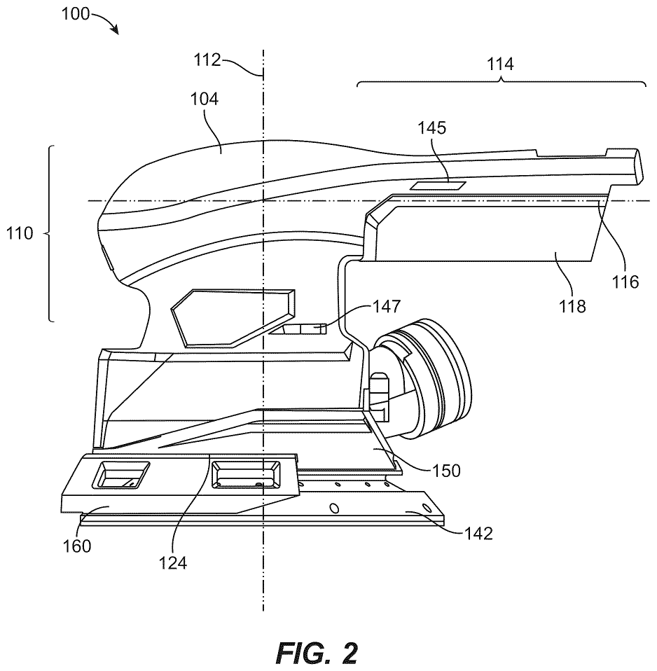

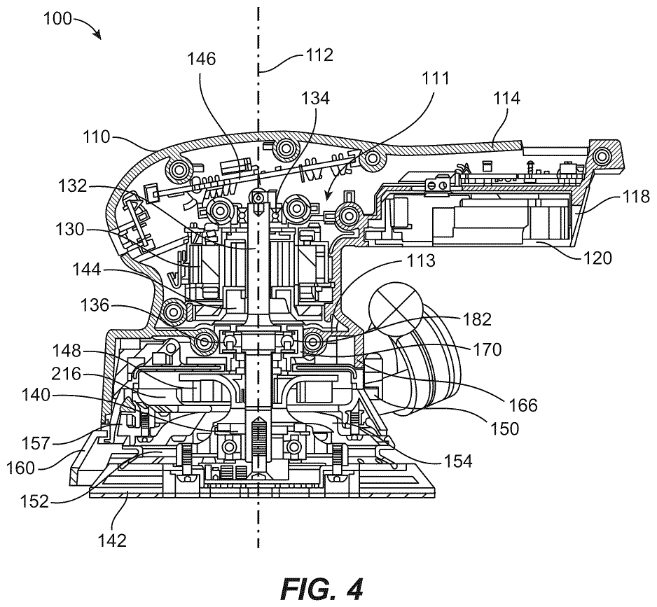

With reference to FIG. 4, the motor housing portion 110 includes a motor 130 disposed therein. Specifically, the motor housing portion 110 defines a first cavity 111 in which the motor 130 is disposed. For example, the motor 130 is a brushless direct current (BLDC) motor that receives electrical current, i.e., power, from the removable battery pack that is engaged with the battery receptacle 118. The motor 130 includes a motor shaft 132 that rotates on a first bearing 134 and a second bearing 136. In other words, the first bearing 134 and the second bearing 136 support the motor shaft 132 for rotation. The motor shaft 132 defines the motor axis 112. That is, the motor shaft 132 rotates about the motor axis 112. An eccentric drive unit 140 is coupled to the motor shaft 132. The motor shaft 132 drives the eccentric drive unit 140 and the eccentric drive unit 140 is configured to convert rotation of the motor shaft 132 to an orbit motion around the motor axis 112. A backing pad 142 is removably attached to the eccentric drive unit 140. A sanding disc (not shown) is removably attached to the backing pad 142. FIG. 4 further shows a cooling fan 144 that is disposed on the motor shaft 132 above the second bearing 136. The cooling fan 144 rotates with the motor shaft 132 to draw air in through an inlet 145 (FIG. 2) on the handle portion 114 and into the motor housing portion 110 to cool the motor 130 and a circuit board 146 during operation of the random orbit sander 100. An exhaust outlet 147 (FIG. 2) is formed in each of the housing shells 104, 106, opposite each other, to provide air exit channels for the air flow generated by the cooling fan 144.

As further illustrated in FIG. 4, a dust fan 148 is disposed on the motor shaft 132 below the second bearing 136 and above the eccentric drive unit 140 and the backing pad 142 mounted thereon. The dust fan 148 is directly driven by the motor 130 and is part of a dust collection assembly 150. The dust collection assembly 150 is formed separately from the housing 102. Alternatively, the dust collection assembly 150 is integrally, and monolithically, formed with the housing 102. During operation, the dust fan 148 rotates with the motor shaft 132 to pull air, and dust, away from the dust collection assembly 150. A vacuum source is also selectively connected to the dust collection assembly 150 to induce an airflow and draw dust and debris away from the dust collection assembly 150. FIG. 4 further shows a brake pad 152 removably mounted on a brake pad bracket 154. The brake pad 152 is fixed with respect to the brake pad bracket 154 while the backing pad 142 rotates relative to the brake pad 152. The brake pad 152 is flexible and is biased into contact with the backing pad 142. The brake pad 152 slows the backing pad 142 when the motor 130 is de-energized. The random orbit sander 100 further includes an edge guard 160 that is removably engaged with the random orbit sander 100. The edge guard 160 (FIG. 2) at least partially surrounds the backing pad 142 and prevents the random orbit sander 100 and the backing pad 142 thereof from running into vertical structures extending from a workpiece, e.g., the inner wall of a cabinet.

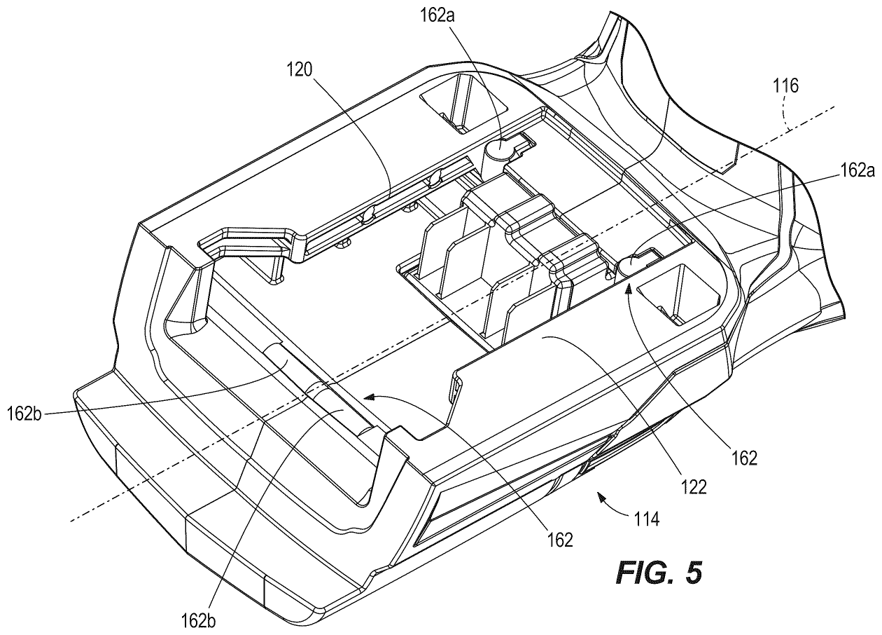

With reference to FIG. 5, the random orbit sander 100 further includes dampers 162 disposed in the battery receptacle 118 to inhibit a battery from moving (vibrating) relative to the battery receptacle 118. The dampers 162 also tighten the connection between the battery and the battery receptacle 118 by reducing slop (or play) between the battery and the battery receptacle 118. There is a first set of dampers 162a adjacent the guide rails 120, 122 and a second set of dampers 162b. The first set of dampers 162a are configured to abut a front of the battery, while the second set of dampers 162b are configured to abut the top of the battery. The first set of dampers 162a, for example, inhibit movement (i.e., vibration) of the battery relative to the battery receptacle 118 along a direction parallel to the handle axis 116. In contrast, the second set of dampers 162b, for example, inhibit movement (i.e., vibration) of the battery relative to the battery receptacle 118 along a direction parallel to the motor axis 112. The dampers 162 are flexible and composed of an elastomeric material (e.g., rubber).

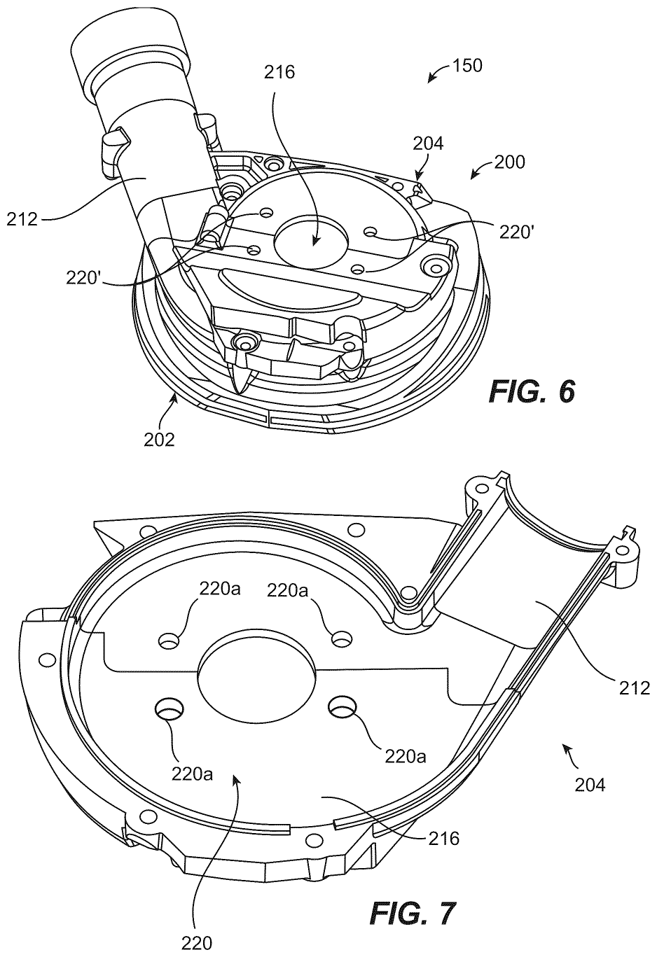

FIGS. 6 and 7 illustrate the details of the dust collection assembly 150. As shown, the dust collection assembly 150 includes a dust shroud 200 having a lower shroud 202 and an upper shroud 204 affixed to the lower shroud 202 by one or more fasteners. The upper shroud 204 is located above the lower shroud 202. The lower shroud 202 is a single monolithic piece. In other words, the lower shroud 202 is integrally formed, or molded, as a single piece.

The dust shroud 200 defines a dust channel 212, as shown in FIG. 7, formed around the dust fan 148 of the dust collection assembly 150 when installed in the random orbit sander 100.

Specifically, the dust shroud 200 defines a second cavity 216 in which the dust fan 148 is disposed.

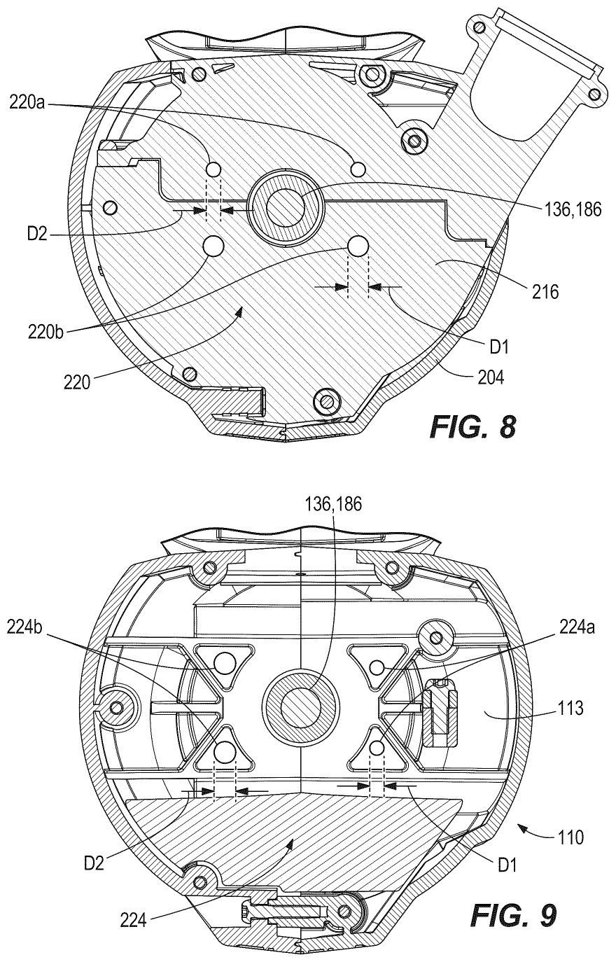

With reference to FIGS. 6-9, the dust shroud 200 includes a first plurality of apertures 220 (FIG. 6), while the wall 113 of the motor housing portion 110 includes a second plurality of apertures 224 (FIG. 9). The first and second plurality of apertures 220, 224 allow the motor housing portion 110 and the dust collection assembly 150 to be in fluid communication with each other. Specifically, the first cavity 111 of the motor housing portion 110 and the second cavity 216 of the dust shroud 200 are in fluid communication with each other via the first and second plurality of apertures 220, 224. In some embodiments, as shown in FIGS. 7 and 8, the first plurality of apertures 220 include a first set of apertures 220a defining a first diameter D1 (FIG. 8) and a second set of apertures 220b defining a second diameter D2 that is greater than the first diameter D1. The first diameter D1 of the first set of apertures 220a each equals 4.0 millimeters, while the second diameter D2 of the second set of apertures 220b each equals 6.5 millimeters. There are two apertures in the first set of apertures 220a and two apertures in the second set of apertures 220b, although in other embodiments there may be fewer or greater than two apertures for each set 220a, 220b. As a result, the first plurality of apertures 220 define a venting area between approximately 85 square millimeters to approximately 95 square millimeters. Specifically, the first plurality of apertures 220 define a venting area of approximately 91.5 square millimeters. In other embodiments, as shown in FIG. 6, the first plurality of apertures 220′ may be the same diameter.

As shown in FIG. 9, the second plurality of apertures 224 include a first set of apertures 224a defining a first diameter D1 and a second set of apertures 224b defining a second diameter D2 that is greater than the first diameter D1. The first diameter D1 of the first set of apertures 224a each equals 4.0 millimeters, while the second diameter D2 of the second set of apertures 224b each equals 5.0 millimeters. There are two apertures in the first set of apertures 224a and two apertures in the second set of apertures 224b, although in other embodiments there may be fewer or greater than two apertures for each set 224a, 224b. As a result, the second plurality of apertures 224 define a venting area between approximately 60 square millimeters to approximately 70 square millimeters. Specifically, the second plurality of apertures 224 define a venting area of approximately 64.4 square millimeters. Although not shown, in some embodiments, the second plurality of apertures 224 may be the same diameter.

Thus, between the first plurality of apertures 220 and the second plurality of apertures 224, a total venting area is defined between approximately 150 square millimeters to approximately 165 square millimeters. Specifically, the first plurality of apertures 220 and the second plurality of apertures 224 together define a total venting area of approximately 155.9 square millimeters.

The first plurality of apertures 220 and the second plurality of apertures 224 are shaped as circles, while in other embodiments, the first and second plurality of apertures 220, 224 may alternatively be shaped as slots, ovals, squares, or any other shape.

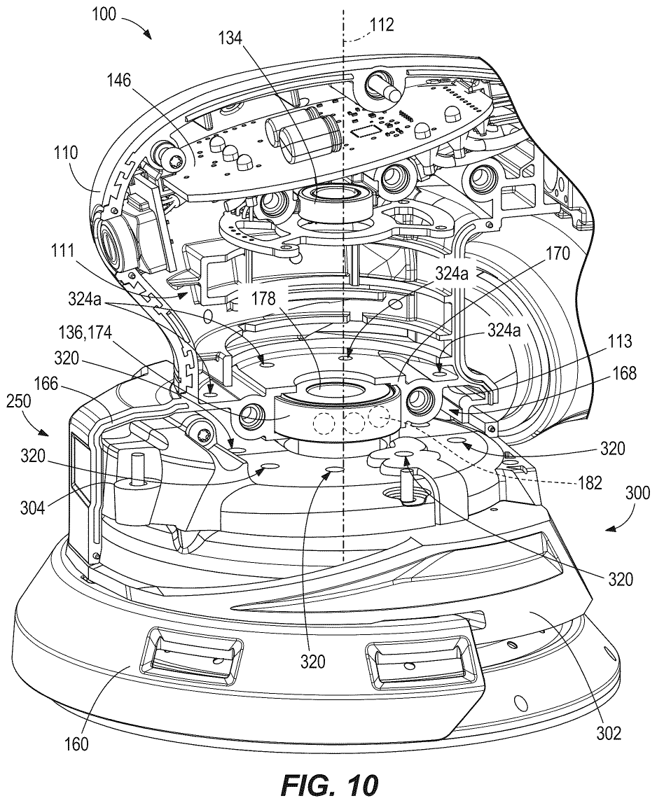

FIGS. 10-12 illustrate the details of another dust collection assembly 250 that is configured to be installed within the random orbit sander 100 in lieu of the dust collection assembly 150 described above. As shown, the dust collection assembly 250 includes a dust shroud 300 having a lower shroud 302 (or a first shroud) and an upper shroud 304 (or a second shroud) affixed to the lower shroud 302 by one or more fasteners. The upper shroud 304 is located above the lower shroud 302. The dust shroud 300 surrounds the dust fan 148 when the dust collection assembly 250 is installed in the random orbit sander 100. Specifically, the dust shroud 300 defines the second cavity 216 in which the dust fan 148 is disposed.

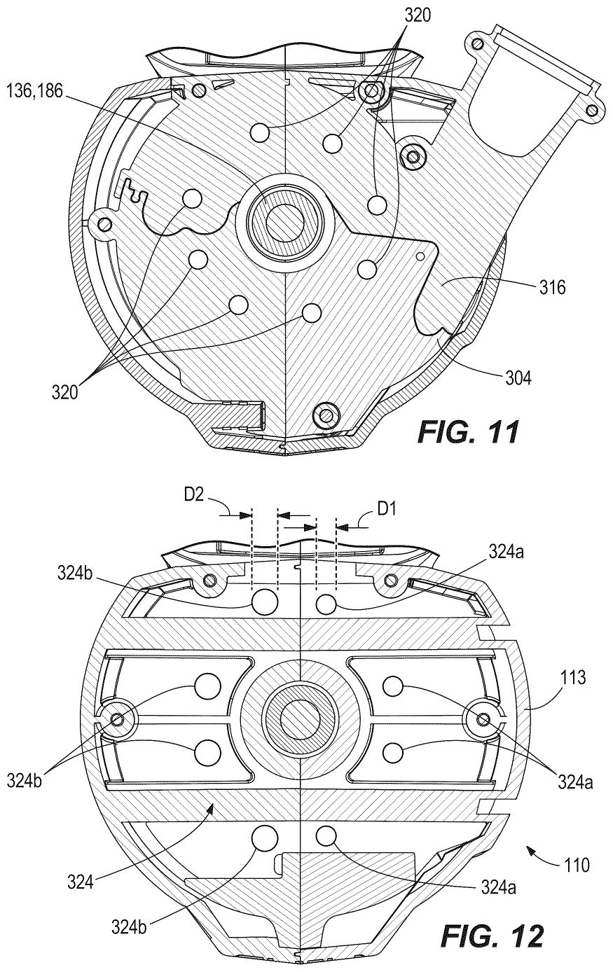

With continued reference to FIGS. 10-12, the dust shroud 300 includes a first plurality of apertures 320 (FIGS. 10 and 11), while the wall 113 of the motor housing portion 110 includes a second plurality of apertures 324 (FIG. 12). The first and second plurality of apertures 320, 324 allow the motor housing portion 110 and the dust collection assembly 250 to be in fluid communication with each other. Specifically, the first cavity 111 of the motor housing portion 110 and the second cavity 316 of the dust shroud 300 are in fluid communication with each other via the first and second plurality of apertures 320, 324. In some embodiments, as shown in FIGS. 10 and 11, the first plurality of apertures 320 all define the same diameter approximately equal to 5.0 millimeters. There are eight apertures in the first plurality of apertures 320, although in other embodiments there may be fewer or greater than eight apertures. As a result, the first plurality of apertures 320 define a venting area between approximately 150 square millimeters to approximately 160 square millimeters. Specifically, the first plurality of apertures 320 define a venting area of approximately 157.1 square millimeters.

As shown in FIG. 12, the second plurality of apertures 324 include a first set of apertures 324a defining a first diameter D1 and a second set of apertures 324b defining a second diameter D2 that is greater than the first diameter D1. The first diameter D1 of the first set of apertures 324a each equals 4.0 millimeters, while the second diameter D2 of the second set of apertures 324b each equals 5.0 millimeters. There are four apertures in the first set of apertures 324a and four apertures in the second set of apertures 324b, although in other embodiments there may be fewer or greater than four apertures for each set 324a, 324b. As a result, the first plurality of apertures 324 define a venting area between approximately 120 square millimeters to approximately 130 square millimeters. Specifically, the first plurality of apertures 324 define a venting area of approximately 128.8 square millimeters. Although not shown, in some embodiments, the second plurality of apertures 324 may be the same diameter.

Thus, between the first plurality of apertures 320 and the second plurality of apertures 324, a total venting area is defined between approximately 280 square millimeters to approximately 290 square millimeters. Specifically, the first plurality of apertures 320 and the second plurality of apertures 324 together define a total venting area of approximately 285.9 square millimeters.

The first plurality of apertures 320 and the second plurality of apertures 324 are shaped as circles, while in other embodiments, the first and second plurality of apertures 320, 324 may alternatively be shaped as slots, ovals, squares, or any other shape.

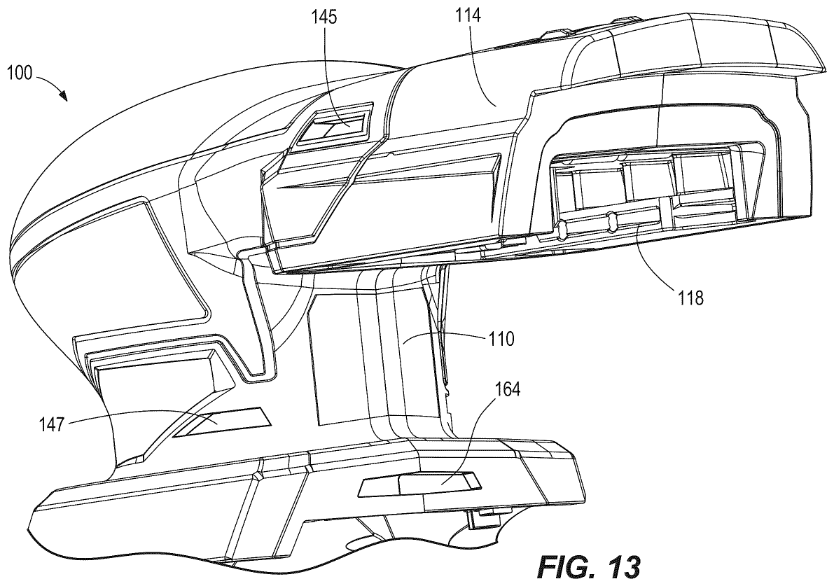

With reference to FIG. 13, the random orbit sander 100 further includes an opening 164 that extends through the housing 102 and is disposed between the handle portion 114 and the dust shroud 200, 300. Specifically, the opening 164 extends through a shroud portion 166 of the housing 102. At least a portion of the dust shroud 200, 300 is received in the shroud portion 166 of the housing 102. The opening 164 effectively places an interior of the orbit sander 100 in fluid communication with an exterior surrounding of the orbital sander 100. That is, the opening 164 places the first cavity 111 and the second cavity 216 in fluid communication with the exterior surroundings of the random orbit sander 100 (i.e., atmosphere). In other words, the opening 164 simultaneously places the motor housing portion 110 and the dust collection assembly 150, 250 in fluid communication with the atmosphere surrounding the random orbit sander 100. The opening 164 extends into an intermediate cavity 168 that is situated between the first cavity 111 and the second cavity 216. The intermediate cavity 168 surrounds the second bearing 136, which is disposed within a bearing pocket 170 that at least partially forms the intermediate cavity 168. That is, the second bearing 136 is supported within the bearing pocket 170. The intermediate cavity 168 is also formed by the wall 113 of the motor housing portion 110, the dust shroud 200, 300, and the shroud portion 166, such that the intermediate cavity 168 is in fluid communication with the first plurality of apertures 220, 320 and the second plurality of apertures 224, 324. As a result, the opening 164 is in fluid communication with the first plurality of apertures 220, 320 and the second plurality of apertures 224, 324.

When the motor 130 is running, the motor housing portion 110 (or first cavity 111) is subject to a high or first pressure (i.e., a high-pressure region is created) due to the cooling fan 144 pushing air out of the motor housing portion 110. At the same time, when the dust collection assembly 150, 250 is connected to a vacuum source, an airflow is created and the dust collection assembly 150, 250 (or second cavity 216) is subject to a low or second pressure (i.e., a low-pressure region) when a vacuum is connected to the dust channel 212. Thus, a pressure differential is created between the motor housing portion 110 and the dust collection assembly 150, 250, at which point the second bearing 136 may experience stress since the second bearing 136 is disposed between the motor housing portion 110 and the dust collection assembly 150, 250, as explained in further detail below. Specifically, the pressure differential may equalize through any crevice, such as the bearing pocket 170, causing undue force on the second bearing 136. The second bearing 136 is a standard roller bearing including an outer race 174 interfaced with the bearing pocket 170, an inner race 178 interfaced with the motor shaft 132, a plurality of rollers 182 between the outer race 174 and the inner race 178, and an annular seal 186 extending between the inner race 178 and the outer race 174. The undue force may inadvertently cause deformation of the seal 186 and/or evacuation of lubrication (e.g., grease, etc.) within the second bearing 136. In particular, the pressure differential may cause the seals to malfunction (e.g., leak, tear break, etc.) over time, causing the lubricant—which is disposed between the outer race 174, the inner race 178, and the seal 186—to escape and damage the second bearing 136 as the plurality of rollers 182 rollers fail due to the accumulated heat and friction with the outer and inner races 174, 178. One advantage of the random orbit sander 100 is the ability to equalize (or reduce) the pressure differential between the motor housing portion 110 and the dust collection assembly 150, 250 more efficiently. For example, the pressure differential may equalize (or at least reduce) via the first plurality of apertures 220, 320, the second plurality of apertures 224, 324, and the opening 164, or other similar openings or gaps. The apertures 220, 224, 320, 324 and the opening 164 cooperate to allow passage of any airflow from the motor housing portion 110 and the dust collection assembly 150, 250 and redirect such airflow around the second bearing 136 and the bearing pocket 170.

Furthermore, pressure is a product of force per area. The apertures 220, 224, 320, 324 and the opening 164 increase the surface area (i.e., internal surfaces of the housing 102 and the dust shroud 200, 300) on which the force exerts. The force (via vacuum source and/or fans 144, 148) on the area remains relatively unchanged. As a result, the same force is being exerted on a larger area, causing the pressure (or pressure differential between the motor housing portion 110 and the dust collection assembly 150, 250) to reduce. Thus, the apertures 220, 224, 320, 324 and the opening 164 help reduce the pressure differential between the motor housing portion 110 and the dust collection assembly 150, 250 by increasing the area that is subject to the force.

Although the disclosure has been described in detail with reference to certain preferred embodiments, variations and modifications exist within the scope and spirit of one or more independent aspects of the disclosure as described.

1. An orbital sander comprising:
a housing defining a handle portion and a motor housing portion;
a motor within the motor housing portion and including a motor shaft defining a motor axis;
an eccentric drive unit coupled to the motor shaft and configured to convert rotation of the motor shaft to an orbit motion around the motor axis;
a battery receptacle on the handle portion that is configured to receive a battery pack for providing electrical current to the motor;
a backing pad coupled to the eccentric drive unit for orbital motion about the motor axis; and
a dust collection assembly including a dust shroud into which an airflow containing dust created during a sanding operation is induced,
wherein the motor housing portion and the dust shroud are in fluid communication with each other.

2. The orbital sander of claim 1, wherein the dust collection assembly further includes a dust fan disposed within the dust shroud, and wherein the dust fan is directly driven by the motor shaft.

3. The orbital sander of claim 1, wherein the dust shroud includes a first plurality of apertures and the motor housing portion includes a second plurality of apertures, and wherein the motor housing portion is in fluid communication with the dust shroud via, in sequence, the second plurality of apertures and the first plurality of apertures.

4. The orbital sander of claim 3, wherein the first plurality of apertures includes a first set of apertures having a first diameter and a second set of apertures having a second diameter that is greater than the first diameter.

5. The orbital sander of claim 3, wherein the second plurality of apertures includes a first set of apertures having a first diameter and a second set of apertures having a second diameter that is greater than the first diameter.

6. The orbital sander of claim 3, wherein the first plurality of apertures and the second plurality of apertures collectively define a venting area of approximately 150 square millimeters to approximately 290 square millimeters.

7. The orbital sander of claim 3, wherein the housing further defines a shroud portion in which at least a portion of the dust shroud is received and an opening extending through the shroud portion of the housing to communicate with an exterior surroundings of the orbital sander, wherein the opening is in fluid communication with the dust shroud via the first plurality of apertures, and wherein the opening is in fluid communication with the motor housing portion via the second plurality of apertures, such that the dust shroud and the motor housing portion are simultaneously in fluid communication with the exterior surroundings of the orbital sander via the opening.

8. The orbital sander of claim 1, further comprising a bearing that supports the motor shaft for rotation and that is located within a bearing pocket between the motor housing portion and the dust shroud.

9. The orbital sander of claim 8, wherein the housing further defines a shroud portion in which at least a portion of the dust shroud is received, wherein the motor housing portion and the dust shroud are in fluid communication with each other via a plurality of apertures, and wherein the plurality of apertures reduce a pressure differential between the motor housing portion and the shroud portion of the housing.

10. An orbital sander comprising:
a housing defining a handle portion and a motor housing portion;
a motor within the motor housing portion and including a motor shaft defining a motor axis;
an eccentric drive unit coupled to the motor shaft and configured to convert rotation of the motor shaft to an orbit motion around the motor axis;
a backing pad coupled to the eccentric drive unit for orbital motion about the motor axis;
a dust collection assembly including a dust shroud in which a low-pressure region is created for drawing dust away from the backing pad;
a bearing supported within a bearing pocket that is disposed between the motor housing portion and the dust shroud; and
an aperture that fluidly communicates the motor housing portion with the dust shroud and that transmits airflow within the motor housing portion around the bearing pocket and toward the low-pressure region.

11. The orbital sander of claim 10, wherein the dust collection assembly further includes a dust fan disposed within the dust shroud, and wherein the dust fan is directly driven by the motor shaft.

12. The orbital sander of claim 11, wherein the aperture is a first plurality of apertures extending through the dust shroud, and wherein the motor housing portion includes a second plurality of apertures that fluidly communicate the motor housing portion and the dust shroud.

13. The orbital sander of claim 12, wherein the first plurality of apertures includes a first set of apertures having a first diameter and a second set of apertures having a second diameter that is greater than the first diameter.

14. The orbital sander of claim 12, wherein the second plurality of apertures includes a first set of apertures having a first diameter and a second set of apertures having a second diameter that is greater than the first diameter.

15. The orbital sander of claim 12, wherein the first plurality of apertures and the second plurality of apertures collectively define a venting area of approximately 150 square millimeters to approximately 290 square millimeters.

16. The orbital sander of claim 12, wherein the housing defines a shroud portion in which at least a portion of the dust shroud is received and an opening extending through the shroud portion of the housing to communication with an exterior surroundings of the orbital sander, wherein the opening is in fluid communication with the dust shroud via the first plurality of apertures, and wherein the opening is in fluid communication with the motor housing portion via the second plurality of apertures, such that the dust shroud and the motor housing portion are simultaneously in fluid communication with the exterior surroundings of the orbital sander via the opening.

17. The orbital sander of claim 10, wherein the motor shaft is rotatably supported within the housing by the bearing.

18. The orbital sander of claim 17, wherein the aperture reduces pressure differential between the motor housing portion and the dust shroud.

19. The orbital sander of claim 10, wherein the dust shroud is selectively coupled to a vacuum for creating the low-pressure region.

20. The orbital sander of claim 19, wherein the bearing includes an outer race interfaced with the bearing pocket, an inner race interfaced with the motor shaft, a plurality of rollers between the outer race and the inner race, and an annular seal extending between the inner race and the outer race.

21. The orbital sander of claim 20, wherein the annular seal is exposed to the low-pressure region within the dust shroud, and wherein the aperture reduces a pressure differential on the annular seal.

22-27. (canceled)
